(19) United States
(12) Patent Application Publication
(10) Pub. No.: US 2022/0048581 A1
(43) Pub. Date: Feb. 17, 2022

(54) Sliding Tailgate

(71) Applicants: Hyundai Motor Company, Seoul (KR); Kia Motors Corporation, Seoul (KR)

(72) Inventor: Dong Hee Ma, Hwaseong-si (KR)

(21) Appl. No.: 17/151,486

(22) Filed: Jan. 18, 2021

(30) Foreign Application Priority Data
Aug. 11, 2020 (KR) 10-2020-0100248

(51) Int. Cl. B62D 33/027; B62D 33/03; B60J 5/12

(52) U.S. Cl. CPC B62D 33/0276; B60J 5/12; B62D 33/03

(57) ABSTRACT

A sliding tailgate includes a moving main body configured to be located on at least a portion of a rear surface of a vehicle, roof levers located at both side ends of a front portion of the moving main body and configured to be moved along roof rail units, tilting units configured to rotate the roof levers thereabout so as to tilt the front portion of the moving main body, rail units configured to be located on a vehicle body and coupled to roller units located at a rear end of the moving main body so as to provide a moving trajectory of the rear end of the moving main body, drive units located on the moving main body and configured to apply driving force to the roller units, and a controller configured to receive a request for opening the moving main body.

### CROSS-REFERENCE TO RELATED APPLICATIONS

This application claims priority to Korean Patent Application No. 10-2020-0100248, filed on Aug. 11, 2020, which application is hereby incorporated herein by reference.

### TECHNICAL FIELD

The present disclosure relates to a sliding tailgate.

### BACKGROUND

In general, recreational vehicles (RVs) or sport utility vehicles (SUVs) refer to vehicles which are used as a transportation means for commuting in normal times and are used as a leisure means which is useful for a driver to spend time with his/her family on the weekend. In most of these multi-purpose vehicles, seats are arranged in three rows. A tailgate serving as a door such that persons and cargo may enter and exit the interior of the vehicle therethrough is mounted behind the third seat.

According to recent vehicle demand trends, most vehicles which are sold are RVs having increased economic feasibility and activity, and consumers are requesting multi-purpose vehicles, such as RVs, which are practical and provide various comforts. In these vehicles, referred to as RVs or SUVs, a tailgate configured to open and close the rear portion of the vehicle is provided so as to increase convenience.

As shown in FIG. 1, a conventional upwards unidirectional opening and closing-type tailgate 10 is opened upwards at a right angle by way of a hinge 3 of a rear roof panel 1 when external force is applied thereto with the hands. The tailgate 10 includes an exterior facing side boa and an interior facing side 10b.

Further, one end of a gas lift 15, which facilitates lifting of the tailgate 10 through rotation and maintains the opened state of the tailgate even when the external force is removed after lifting of the tailgate 10 is completed, is coupled to a concave portion of the tailgate 10 and the other end of the gas lift 15 is coupled to the rear portion of a vehicle body.

In order to close the tailgate 10, when external force is again applied to the tailgate 10 with the hands, the tailgate 10 is closed downwards against the gas pressure of the gas lift 15.

However, the above conventional upwards unidirectional opening and closing-type tailgate 10 is inconvenient when loading or unloading cargo into or from the vehicle, and particularly, if an obstacle is present behind the vehicle, the opening angle of the tailgate 10 may not be ensured depending on the radius of rotation of the tailgate 10 at the right angle, and thus the position of the vehicle must be changed.

The above-described tailgate 10 for vehicles has an integrated structure in which the entire tailgate lo is rotated at the same angle by one hinge, and thus, when the space behind the parked vehicle is insufficient, the tailgate 10 is not capable of being opened and closed. Further, a distance between a hinge portion and the end of the tailgate 10 is long, and thus, a large rotating force is required and it takes a lot of power to open and close the tailgate 10, and moreover, a bent portion of the tailgate 10 is inconvenient when loading cargo into the vehicle.

Korean Patent Application No. 2010-0071946 provides information relevant to the subject matter described herein.

### SUMMARY

The present disclosure relates to a sliding tailgate. Particular embodiments relate to a sliding tailgate which is configured such that a moving main body thereof is opened in a sliding manner and thus does not require a radius of rotation.

Embodiments of the present invention can solve problems associated with the prior art, and an embodiment of the present invention provides a sliding tailgate which may be opened in a sliding manner.

Another embodiment of the present invention provides a sliding tailgate which may be slid towards the upper end of a roof without interference between the roof and a moving main body.

One embodiment of the present invention provides a sliding tailgate including a moving main body located on at least a portion of a rear surface of a vehicle, roof levers located at both side ends of a front portion of the moving main body and configured to be moved along roof rail units, tilting units configured to rotate the roof levers thereabout so as to tilt the front portion of the moving main body, rail units located on a vehicle body and coupled to roller units located at a rear end of the moving main body so as to provide a moving trajectory of the rear end of the moving main body, drive units located on the moving main body and configured to apply driving force to the roller units, and a controller configured to receive a request for opening the moving main body and to control the drive units to apply the driving force to the roller units.

In a preferred embodiment, each of the tilting units may include a guide part located at one end of a corresponding one of the roof levers and configured to be inserted into a corresponding one of the roof rails, a rotation guide part configured to surround at least a portion of an outer surface of the guide part so that the guide part is rotated integrally with the corresponding one of the roof levers, and a deployment part configured such that the guide part is rotated to a position corresponding to the corresponding one of the roof rail units, is inserted into the corresponding one of the roof rail units, and is then moved along the corresponding one of the roof rail units.

In another preferred embodiment, the guide part may include a central shaft configured to pass through the rotation guide part, and the central shaft may be configured to be moved integrally with the guide part along a groove located parallel to the deployment part in the corresponding one of the roof rail units.

In still another preferred embodiment, the rotation guide part may include a rotation regulation part configured to allow the guide part to be rotated to a position parallel to the deployment part.

In yet another preferred embodiment, when the driving force of the drive units is applied and thus the rear end of the moving main body is moved along the rail units, a front end of the moving main body may be tilted by rotation of the roof levers about the tilting units.

In still yet another preferred embodiment, after the front end of the moving main body is tilted, the roof levers may be moved along the roof rail units.

Other aspects and preferred embodiments of the invention are discussed infra.

The above and other features of embodiments of the invention are discussed infra.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only, and thus are not limitative of the present invention, and wherein:

FIG. 1 is a view illustrating the operation of a conventional rotating tailgate mounted on the rear portion of a vehicle;

FIG. 2 is a side view illustrating a vehicle having a sliding tailgate according to one embodiment of the present invention mounted thereon;

FIG. 3A is a view illustrating the configuration of the sliding tailgate according to one embodiment of the present invention;

FIG. 3B is an internal view illustrating connection between a roof lever and a tilting unit of the sliding tailgate according to one embodiment of the present invention;

FIG. 3C is an external view illustrating the connection between the roof lever and the tilting unit of the sliding tailgate according to one embodiment of the present invention;

FIG. 4 is an enlarged view illustrating the rear end of a moving main body of the sliding tailgate according to one embodiment of the present invention;

FIG. 5A is a longitudinal-sectional view of a vehicle in a state in which the sliding tailgate according to one embodiment of the present invention is closed;

FIG. 5B is a view illustrating the operation of the roof levers in the closed state of the sliding tailgate according to one embodiment of the present invention;

FIG. 5C is an enlarged view illustrating the rear end of the moving main body in the closed state of the sliding tailgate according to one embodiment of the present invention;

FIG. 6A is a longitudinal-sectional view of the vehicle in a state in which the sliding tailgate according to one embodiment of the present invention is tilted;

FIG. 6B is a view illustrating the operation of the roof levers in the tilted state of the sliding tailgate according to one embodiment of the present invention;

FIG. 6C is an enlarged view illustrating the rear end of the moving main body in the tilted state of the sliding tailgate according to one embodiment of the present invention;

FIG. 7A is a longitudinal-sectional view of the vehicle in a state in which the sliding tailgate according to one embodiment of the present invention is opened;

FIG. 7B is a view illustrating the operation of the roof levers in the opened state of the sliding tailgate according to one embodiment of the present invention; and

FIG. 7C is an enlarged view illustrating the rear end of the moving main body in the opened state of the sliding tailgate according to one embodiment of the present invention.

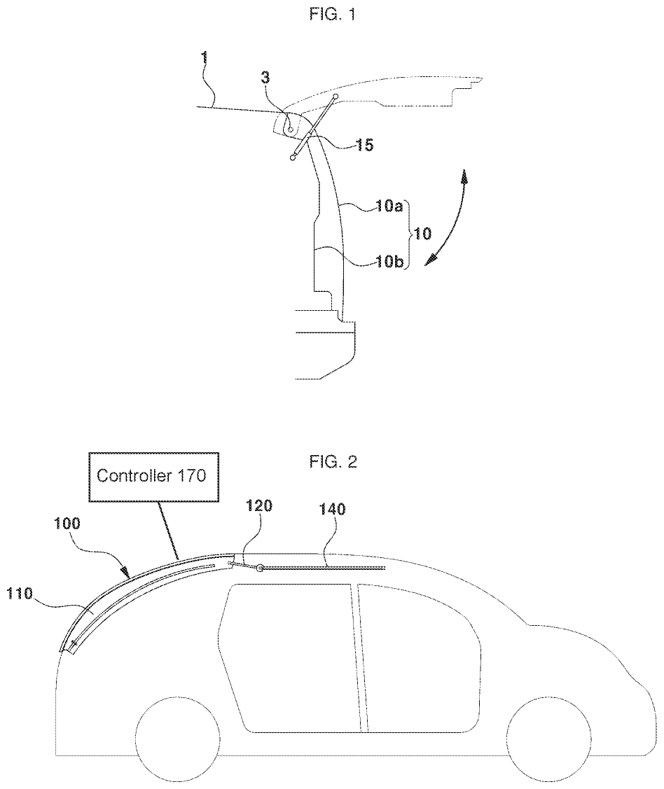

It should be understood that the appended drawings are not necessarily to scale, presenting a somewhat simplified representation of various preferred features illustrative of the basic principles of the invention. The specific design features of embodiments of the present invention as disclosed herein, including, for example, specific dimensions, orientations, locations, and shapes will be determined in part by the particular intended application and use environment.

In the figures, reference numbers refer to the same or equivalent parts of embodiments of the present invention throughout the several figures of the drawing.

### DETAILED DESCRIPTION OF ILLUSTRATIVE EMBODIMENTS

Hereinafter reference will be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments, which may be included within the spirit and scope of the invention as defined by the appended claims.

Further, in the following description of the embodiments, it will be understood that the suffixes “part”, “unit” and “main body” indicate units for processing at least one function or operation, and may be implemented using hardware or a combination between hardware and hardware.

In addition, in the following description of the embodiments, it will be understood that the term “tilting” of an element means a popped-up state of one end of a tailgate, and a tilted state includes the temporary shape or the continuous shape of the tailgate.

Furthermore, in the following description of the embodiments, it will be understood that the term “front portion” or “rear portion” as an expression in the moving direction of an element is used to distinguish the position of the element based on the length direction of a vehicle, and the direction is not limited in the description below.

Hereinafter, the embodiments of the present invention will be described in detail with reference to the accompanying drawings and, in the following description of the embodiments of the present invention, the same or similar elements will be denoted by the same reference numerals even though they are depicted in different drawings and a detailed description thereof will be omitted when it may make the subject matter of the present invention rather unclear.

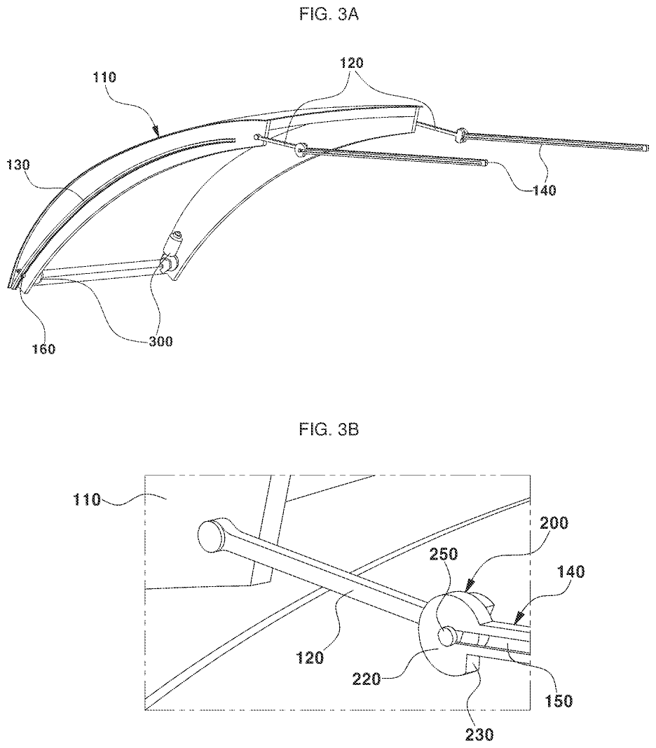

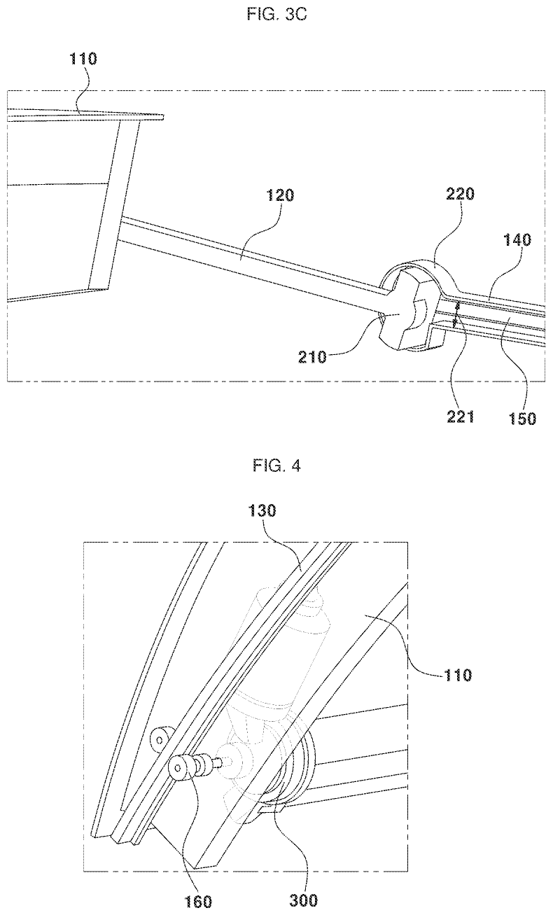

FIG. 2 is a side view illustrating a vehicle having a sliding tailgate 100 according to one embodiment of the present invention mounted thereon, and FIGS. 3A and 3B are a view illustrating the configuration of the sliding tailgate 100 and an enlarged view illustrating connection relationships between elements thereof, respectively. FIG. 3C is a view illustrating connection relationships between elements of a tilting unit 200.

The sliding tailgate 100 according to embodiments of the present invention is located on at least a portion of the rear surface of a vehicle, and is configured to be automatically or manually opened in response to a signal from a user or the position of the user. In the illustrated embodiment, the sliding tailgate 100 is located at the upper end of the rear surface of a vehicle, and is configured to be slidably moved towards the upper end of a roof.

The sliding tailgate 100 includes a moving main body 110 formed of glass or a panel and configured to face the rear surface of the vehicle, and roof levers 120 coupled to the moving main body 110 so as to tilt the front end of the moving main body 110 and configured to allow the tilted moving main body 110 to be moved along roof rail units 140 located on the roof of the vehicle.

The sliding tailgate 100 includes one or more roller units 160 provided on the moving main body 110 so as to move the moving main body 110 along rail units 130 formed on a vehicle body facing both side surfaces of the moving main body 110, and drive units 300 configured to apply driving force to the roller units 160. Further, the sliding tailgate 100 includes a controller 170 configured to apply the power of the drive units 300 to the sliding tailgate 100 so as to open the tailgate 100 when a user's opening signal or a predetermined electrical signal is applied.

The controller 170 rotates the drive units 300, each of which is coupled to at least one roller of the roller unit 160, so as to move the moving main body 110 along the rail units 130. Further, the drive units 300 are located at both sides of the moving main body 110 so as to apply driving force to both sides of the moving main body 110.

When the driving force of the drive unit 300 is applied in response to a signal first received by the controller 170, the rear portion of the moving main body 110 is moved along the rail units 130, and the front portion of the moving main body 110 is popped up in response to rotation of the roof levers 120. More particularly, the driving force of the drive unit 300 is applied to the front portion of the moving main body 110 in the length direction of the moving main body 110, and the applied driving force is applied to the roof levers 120 rotated about tilting units 200. Therefore, each of the roof levers 120 is configured so as to be rotated about a corresponding tilting unit 200 provided between one end of the roof lever 120 and the roof rail unit 140. That is, when the driving force is applied to the tailgate 100 in the closed state, the roof levers 120 are rotated so as to move the front portion of the moving main body 110 in the height direction of the vehicle, and thus, the tilted state of the front portion of the moving main body 110 is maintained.

The tilting unit 200 includes a guide part 210 located at one end of the roof lever 120, a rotation guide part 220 configured to surround the guide part 210 so that the guide part 210 is rotated integrally with the roof lever 120, and a deployment part 240 formed along the roof rail unit 140 and configured to extend through an opening 221 formed in one end of the rotation guide part 220 facing the roof rail unit 140.

In one embodiment of the present invention, the guide part 210 is located inside the rotation guide part 220, and is rotated about a central shaft 250 passing through the rear surface of the rotation guide part 220. The guide part 210 may be formed in the shape of a rod which is rotated along the inner circumferential surface of the rotation guide part 220 having a cylindrical shape, and the rod may be provided integrally with the central shaft 250 of the rotation guide part 220 and thus be inserted into the deployment part 240. Further, the central shaft 250 may be moved along a groove 150 formed corresponding to the deployment part 240 of a roof rail. In an embodiment of the present invention, the rod shape may include any structure having a rectangular cross-section having long sides 210a and short sides 210b.

That is, the guide part 210 formed in the shape of a rod is rotated along the inner surface of the rotation guide part 220 so as to convert the moving main body 110 into the tilted state. Therefore, in the popped-up state of the front portion of the moving main body 110, the guide part 210 is rotated to a position corresponding to the opening 221 of the rotation guide part 220. Thereafter, when the driving force of the drive unit 300 is applied, the guide part 210 is moved along the deployment part 240 connected to the opening 221 of the rotation guide part 220 so as to move the moving main body 110 towards the upper end of the roof.

As shown in FIGS. 3B and 3C, the guide part 210 is rotated along the inner circumferential surface of the cylindrical rotation guide part 220. Further, the guide part 210 is rotated integrally with the roof lever 120 along the central shaft 250 passing through the rear surface of the rotation guide part 220.

Further, as shown in FIG. 3B, one end of the roof lever 120 is coupled to the moving main body 110, and the guide part 210 is formed integrally with the other end of the roof lever 120. The guide part 210 is formed in the shape of a rod, and is rotated about the central shaft 250 passing through the rear surface of the rotation guide part 220.

In addition, as shown in FIG. 3C, in the initially closed state of the moving main body 110, the long sides 210a of the rod-shaped guide part 210 remain almost perpendicular to the opening 221 of the rotation guide part 220, and thereby, the guide part 210 may be prevented from being moved to the roof rail unit 140 along the deployment part 240.

Further, the moving main body 110 is configured such that the guide part 210 is preemptively rotated along the inner circumferential surface of the rotation guide part 220 based on an angular difference between the direction of the long sides 210a of the guide part 210 and the position of the opening 221 at an initial point in time when driving force is applied to the moving main body 110. Therefore, the moving main body 110 is configured such that the front portion of the moving main body 110 is rotated upwards together with the roof levers 120 and thereby tilting of the front portion of the moving main body 110 is performed.

The tilted height of the moving main body 110 may vary depending on an angle formed by the openings 221 and the central lines of the guide parts 210 in the length direction, and moreover, be determined by the length of the roof levers 120.

When the long sides 210a of the rod-shaped guide part 210 are rotated to a position corresponding to the opening 221 of the rotation guide part 220, the guide part 210 is moved along the deployment part 240 of the roof rail unit 140. The deployment part 240 is configured to have the same width as the short sides 210b of the guide part 210, and thus limits the upward and downward movement of the guide part 210 and guides the movement of the guide part 210 in the length direction of the roof rail unit 140 when the guide part 210 is moved along the roof rail unit 140. Further, the groove 150 formed in the roof rail unit 140 along the deployment part 240 is configured such that the central shaft 250 of the guide part 210 is moved along the groove 150.

In one embodiment of the present invention, the deployment parts 240 limit the upward and downward movement or the rotational movement of the guide parts 210, each of which is located at one end of the corresponding one of the roof levers 120, and thereby, the roof levers 120 maintain the state of being popped up from the upper surface of the roof and are moved in the length direction of the roof. That is, the roof levers 120 are rotated and moved, and thereby, the moving main body 110 maintains the tilted height thereof and is moved along the roof rail units 140.

FIG. 4 is a view illustrating the drive unit 300 and the roller unit 160 located at the rear end of the moving main body 110 according to one embodiment of the present invention.

The sliding tailgate 100 includes the drive unit 300 which is located inside the moving main body 110, receives a signal from the controller 170 and then provides driving force to the roller unit 160. The drive unit 300 is configured to apply the driving force to at least one of a plurality of rollers of the roller unit 160, and the rear end of the moving main body 110 is moved along the rail units 130 located inside the vehicle body by the roller units 160, to which the driving force is applied.

In one embodiment of the present invention, the roller unit 160 includes two rollers which are provided at upper and lower positions, and the two rollers are configured to directly contact the upper and lower ends of the rail unit 130 so as to limit the upward and downward movement of the moving main body 110. More particularly, the drive unit 300 may be configured to apply rotating force to one roller.

The drive units 300 may be located at both sides of the moving main body 110, and provide the same driving force to the roller units 160 coupled to the rail units 130. Further, the controller 170 may measure the movement distance of the roller units 160 moving along the rail units 130 or the current value of the drive units 300 and thus compensate for the rotating force of the drive units 300 based on the measured movement distance or the roller units 160 or the measured current value.

The drive units 300 are driven depending on the current value applied from the controller 170 in response to driving of the moving main body 110 input to the controller 170, and the applied current value varies in the closed state, the tilted state and the opened state of the moving main body 110. More particularly, the controller 170 may be configured to apply pulse current to the drive units 300, and to control the number of frequency of applications of the pulse current and the application time of the pulse current.

As such, the drive units 300 are configured to apply rotating force to the roller units 160 protruding outwards from the moving main body 110, and the roller units 160 are configured to be moved along the rail units 130 so as to switch the moving main body 110 from the closed state to the tilted state or the opened state.

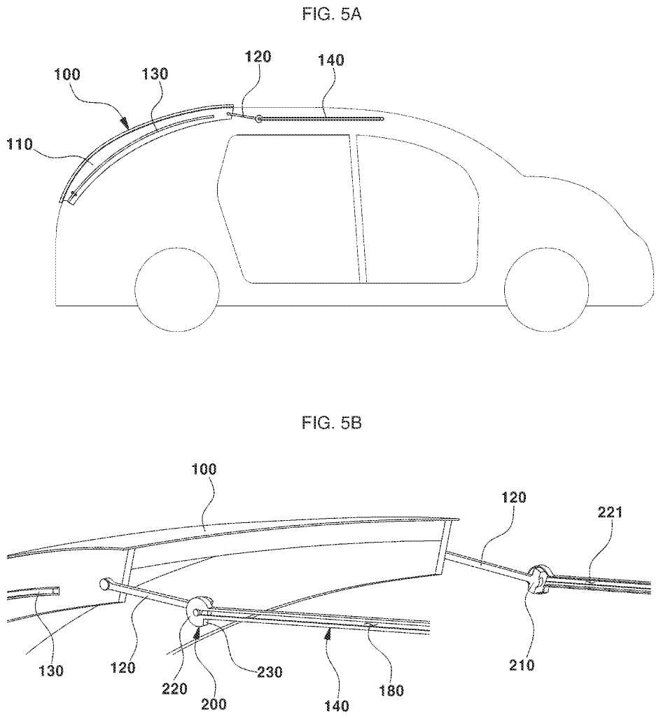

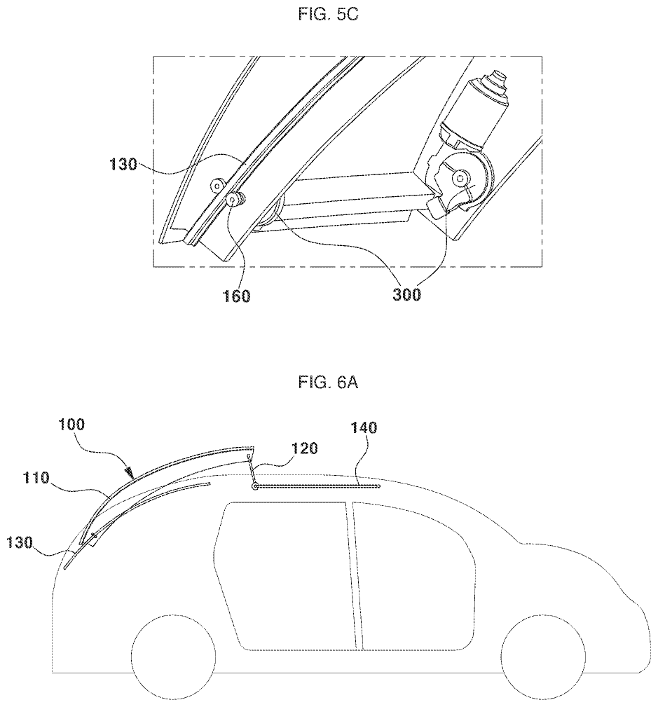

FIG. 5A is a longitudinal-sectional view of the vehicle in the state in which the moving main body 110 according to one embodiment of the present invention is closed, FIG. 5B is a view illustrating connection relationships between the roof levers 120 and the roof rail units 140 in the closed state of the moving main body 110, and FIG. 5C is a view illustrating the rear end of the moving main body 110 including the drive units 300 in the closed state of the moving main body 110.

When the moving main body 110 maintains the closed state, the upper surface of the moving main body 110 is substantially parallel to the roof. More particularly, the roof levers 120 are switched to a state of being substantially parallel to the roof.

Further, in the closed state of the moving main body 110, the long sides 210a of the guide part 210 are located so as to be substantially perpendicular to the opening 221 of the rotation guide part 220, and the roof levers 120 are located in a region in which a rotation regulation part 230 located at one end of the rotation guide part 220 and the guide part 210 contact each other. Therefore, the moving main body 110 is located to remain substantially parallel to the vehicle body.

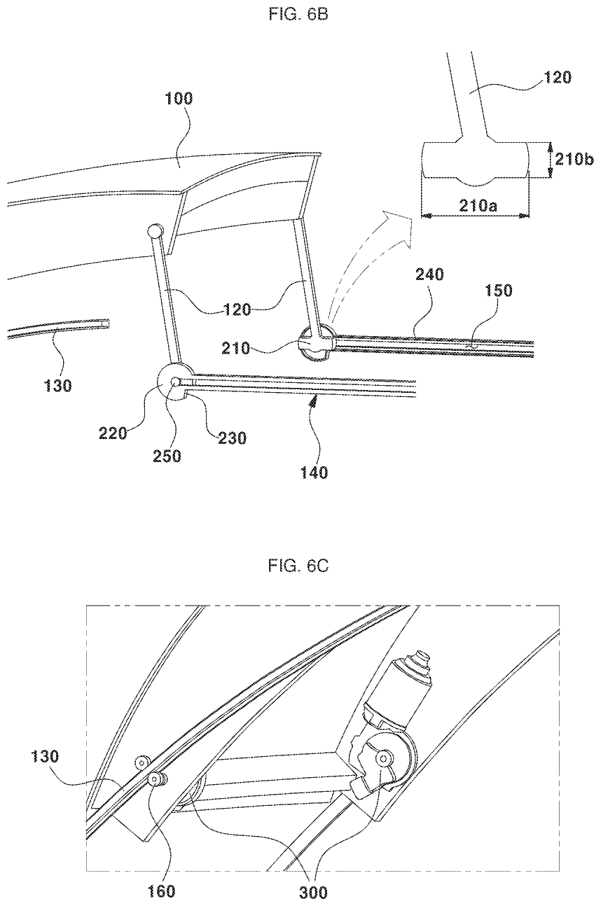

FIGS. 6A to 6C are views illustrating the state in which the front end of the moving main body 110 is tilted.

As shown in FIG. 6A, one end of the moving main body 110 adjacent to the roof of the vehicle is popped up in the height direction of the vehicle. Therefore, the front end of the moving main body 110 is popped up, and the rear end of the moving main body 110 is moved along the rail units 130 located on the side surfaces of the vehicle body so as to enable movement of the front portion of the moving main body 110.

More particularly, when a request for tilting the moving main body 110 is input, the controller 170 applies current to the drive units 300, and the roller units 160 coupled to the drive units 300 are rotated based on the applied current. The rotated roller units 160 are moved along the rail units 130, which are located on the side surfaces of the vehicle body and contact the roller units 160. Thereby, the long sides 210a of the guide parts 210 are rotated along the inner circumferential surfaces of the rotation guide parts 220 and one end of each of the roof levers 120 is popped up from the upper end of the roof, and thus, the front portion of the moving main body 110 integrally with the roof levers 120 is moved towards the upper end of the roof.

Each of the tilting units 200 includes the guide part 210 provided integrally with the other end of the roof lever 120, the rotation guide part 220 connected to the roof rail unit 140 so that the guide part 210 is rotated therein, and the deployment part 240 formed along the roof rail unit 140 connected to the rotation guide part 220 and configured such that the guide part 210 is moved along the opening 221 of the rotation guide part 220 in the length direction of the roof rail unit 140.

In one embodiment of the present invention, in the closed state of the moving main body 110, the drive units 300 are driven so as to tilt the front end of the moving main body 110 and the guide parts 210, each of which is located at the other end of a corresponding one of the roof levers 120, are rotated inside the rotation guide parts 220, and thereby, the front end of the moving main body 110 connected to ends of the roof levers 120 is moved integrally with the rotation of the roof levers 120.

In FIG. 6B, the rotation guide parts 220 are configured to rotate the corresponding ends of the roof levers 120 in the clockwise direction, and the front end of the moving main body no coupled to the ends of the roof levers 120 is rotated integrally with the movement of the roof levers 120.

Here, the roof levers 120 are rotated to positions at which the long sides 210a of the guide parts 210 correspond to the deployment parts 240, and thereby, the roof levers 120 may be located to be substantially perpendicular to the roof rail units 140.

Further, the guide parts 210 include the central shafts 250 passing through the rear surfaces of the rotation guide parts 220, and thereby, the guide parts 210 may be rotated simultaneously with the rotation of the roof levers 120 about the central shafts 250.

When the guide parts 210 are connected to the deployment parts 240 and are thus inserted into the deployment parts 240, the central shafts 250 may be moved integrally with the guide parts 210 along the grooves 150 formed in the roof rail units 140. More particularly, the grooves 150 may be located substantially parallel to the roof rail units 140.

The front portion of the moving main body 110 is tilted as the guide parts 210 are rotated, and the rotation regulation parts 230 configured to rotate the guide parts 210 to regions connected to the deployment parts 240 are formed inside the rotation guide parts 210.

The rotation regulation part 230 is provided at one end of the rotation guide part 220 adjacent to the roof rail unit 140, and may limit the amount of rotation of the guide part 210 so that the long sides 210a of the guide part 210 are rotated to a position corresponding to the length direction of the deployment part 240.

More particularly, the rotation regulation part 230 may be configured to limit the amount of rotation of the guide part 210 so that the guide part 210 is rotated to a position corresponding to the opening 221 of the rotation guide part 220, and determine the position of the guide part 210 in the tilted state so that the guide part 210 may be moved along the deployment part 240 in the length direction of the roof in the upright state of the roof lever 120 when additional driving force is applied from the drive unit 300.

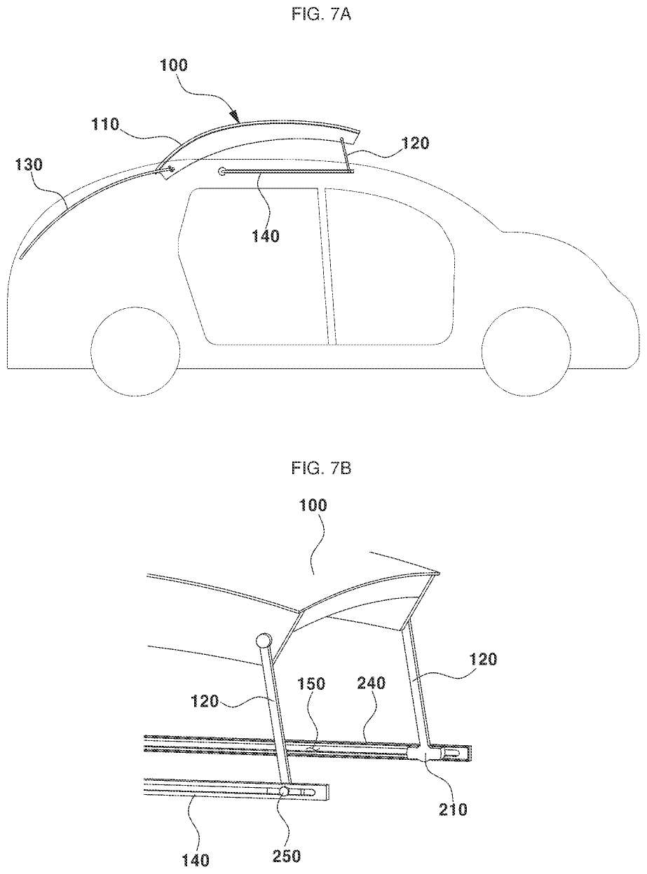

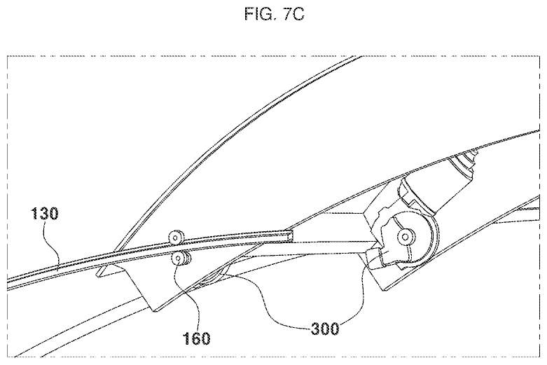

FIG. 7A is a longitudinal-sectional view of the vehicle in the state in which the moving main body 110 is opened, and FIGS. 7B and 7C are views illustrating the coupling relationships between the roof levers 120 and the roof rail units 140 and the positions of the roller units 160 in the opened state of the moving main body 110.

The moving main body 110 is switched to the opened state in response to input for opening the moving main body 110, received by the controller 170, and the controller 170 controls the drive units 300 so as to move the moving main body 110 towards the upper surface of the roof. The roof levers 120 in the tilted state, located at the front end of the moving main body 110, are moved towards the front portion of the roof along the roof rail units 140. More particularly, the guide parts 210 are moved along the deployment parts 240, and the central shafts 250 of the guide parts 210 are moved towards the front end of the roof along the grooves 150 located in the roof rail units 140.

That is, when the moving main body 110 is switched from the closed state to the opened state, the moving main body 110 is primarily switched to the tilted state, and then, the moving main body 110 is moved towards the upper surface of the roof along the roof rail units 140 while maintaining the popped-up state of the front end of the moving main body 110.

Thereby, the moving main body 110 is switched from the tilted state to the opened state, and thus, the roof levers 120 are moved along the roof rail units 140, and the roller units 160 located at the sides of the rear end of the moving main body 110 are moved to positions close to the rear end of the roof along the rail units 130 formed on the side surfaces of the vehicle body. The roof levers 120 are moved along the roof rail units 140 while maintaining a designated angle with the length direction of the deployment part 240, and more particularly, are moved along the upper surface of the roof while maintaining an angle formed between the long sides 210a of the guide parts 210 and the roof levers 120. Therefore, the front end of the moving main body 110 is moved in the length direction along the upper surface of the roof without interfering with the rear end of the roof in the length direction.

As is apparent from the above description, a sliding tailgate according to one embodiment of the present invention may exhibit the following effects through the above-described configuration and connection and usage relationships.

The sliding tailgate according to the embodiment of the present invention may be opened in a sliding manner even when there is no space behind a vehicle including the sliding tailgate, thereby being capable of improving efficiency of use of space.

Further, the sliding tailgate according to the embodiment of the present invention includes a moving main body, which is moved towards the upper end of the roof of the vehicle, thereby being capable of opening more widely.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A sliding tailgate comprising:
a moving main body configured to be located on at least a portion of a rear surface of a vehicle;
roof levers located at both side ends of a front portion of the moving main body and configured to be moved along roof rail units;
tilting units configured to rotate the roof levers so as to tilt the front portion of the moving main body;
rail units configured to be located on a vehicle body and coupled to roller units located at a rear end of the moving main body so as to provide a moving trajectory of the rear end of the moving main body;
drive units located on the moving main body and configured to apply a driving force to the roller units; and
a controller configured to receive a request for opening the moving main body and to control the drive units to apply the driving force to the roller units.

2. The sliding tailgate of claim 1, wherein each of the tilting units comprises:
a guide part located at one end of a corresponding one of the roof levers and configured to be inserted into a corresponding one of the roof rail units;
a rotation guide part configured to surround at least a portion of an outer surface of the guide part so that the guide part is rotated integrally with the corresponding one of the roof levers; and
a deployment part configured such that the guide part is rotated to a position corresponding to the corresponding one of the roof rail units, is inserted into the corresponding one of the roof rail units, and is then moved along the corresponding one of the roof rail units.

3. The sliding tailgate of claim 2, wherein the guide part comprises a central shaft configured to pass through the rotation guide part, and wherein the central shaft is configured to be moved integrally with the guide part along a groove located parallel to the deployment part in the corresponding one of the roof rail units.

4. The sliding tailgate of claim 2, wherein the rotation guide part comprises a rotation regulation part configured to allow the guide part to be rotated to a position parallel to the deployment part.

5. The sliding tailgate of claim 1, wherein, when the driving force of the drive units is applied and the rear end of the moving main body is moved along the rail units, a front end of the moving main body is configured to be tilted by rotation of the roof levers about the tilting units.

6. The sliding tailgate of claim 5, wherein, after the front end of the moving main body is tilted, the roof levers are configured to be moved along the roof rail units.

7. A vehicle comprising:
a vehicle body including a roof;
roof rail units mounted on the roof of the vehicle body;
a tailgate panel located on at least a portion of a rear surface of the vehicle body;
roof levers located at both side ends of a front portion of the tailgate panel and configured to be moved along the roof rail units;
tilting units configured to rotate the roof levers so as to tilt the front portion of the tailgate panel;
rail units located on the vehicle body and coupled to roller units located at a rear end of the tailgate panel so as to provide a moving trajectory of the rear end of the tailgate panel;
drive units located on the tailgate panel and configured to apply a driving force to the roller units; and
a controller configured to receive a request for opening the tailgate panel and to control the drive units to apply the driving force to the roller units.

8. The vehicle of claim 7, wherein each of the tilting units comprises:
a guide part located at one end of a corresponding one of the roof levers and configured to be inserted into a corresponding one of the roof rail units;
a rotation guide part configured to surround at least a portion of an outer surface of the guide part so that the guide part is rotated integrally with the corresponding one of the roof levers; and
a deployment part configured such that the guide part is rotated to a position corresponding to the corresponding one of the roof rail units, is inserted into the corresponding one of the roof rail units, and is then moved along the corresponding one of the roof rail units.

9. The vehicle of claim 8, wherein the guide part comprises a central shaft configured to pass through the rotation guide part, and wherein the central shaft is configured to be moved integrally with the guide part along a groove located parallel to the deployment part in the corresponding one of the roof rail units.

10. The vehicle of claim 8, wherein the rotation guide part comprises a rotation regulation part configured to allow the guide part to be rotated to a position parallel to the deployment part.

11. The vehicle of claim 7, wherein, when the driving force of the drive units is applied and the rear end of the tailgate panel is moved along the rail units, a front end of the tailgate panel is configured to be tilted by rotation of the roof levers about the tilting units.

12. The vehicle of claim 11, wherein, after the front end of the tailgate panel is tilted, the roof levers are configured to be moved along the roof rail units.

13. A tailgate comprising:
a tailgate body configured to be located on at least a portion of a rear surface of a vehicle body;
rail units configured to be located on opposite sides of the rear surface of the vehicle body;
roof rail units configured to be located on opposite sides of a roof of the vehicle body;
roof levers located at opposite sides of an upper end of the tailgate body and configured to be moved along the roof rail units;
tilting units provided between the roof levers and the roof rail unit and configured to rotate the roof levers to tilt the upper end of the tailgate body;
roller units coupled to the rail units and configured to move along the rail units to provide a moving trajectory of a lower end of the tailgate body;
drive units located on the tailgate body and configured to apply a driving force to the roller units; and
a controller configured to receive a request for opening the tailgate body and to control the drive units to apply the driving force to the roller units.

14. The tailgate of claim 13, wherein each of the tilting units comprises:
a guide part located at one end of a corresponding one of the roof levers and configured to be inserted into a corresponding one of the roof rail units;
a rotation guide part configured to surround at least a portion of an outer surface of the guide part so that the guide part is rotated integrally with the corresponding one of the roof levers; and
a deployment part configured such that the guide part is rotated to a position corresponding to the corresponding one of the roof rail units, is inserted into the corresponding one of the roof rail units, and is then moved along the corresponding one of the roof rail units.

15. The tailgate of claim 14, wherein the guide part comprises a central shaft configured to pass through the rotation guide part.

16. The tailgate of claim 15, wherein the central shaft is configured to be moved integrally with the guide part along a groove located parallel to the deployment part in the corresponding one of the roof rail units.

17. The tailgate of claim 14, wherein the guide part has a rod shape and the rotation guide part has a cylindrical shape, and wherein the guide part is provided integrally with a central shaft of the rotation guide part and is configured to be inserted into the deployment part.

18. The tailgate of claim 14, wherein the rotation guide part comprises a rotation regulation part configured to allow the guide part to be rotated to a position parallel to the deployment part.

19. The tailgate of claim 13, wherein, when the driving force of the drive units is applied and the lower end of the tailgate body is moved along the rail units, the upper end of the tailgate body is configured to be tilted by rotation of the roof levers about the tilting units.

20. The tailgate of claim 19, wherein, after the upper end of the tailgate body is tilted, the roof levers are configured to be moved along the roof rail units.
